(19) United States
(12) Patent Application Publication
(10) Pub. No.: US 2026/0370951 A1
(43) Pub. Date: Nov. 19, 2026

(54) ESTIMATION METHOD, ILLUMINATION CONTROL METHOD, NON-TRANSITORY COMPUTER READABLE MEDIUM, CONTROL DEVICE, AND ILLUMINATION CONTROL SYSTEM

(71) Applicant: KYOCERA CORPORATION, Kyoto-shi, Kyoto (JP)

(72) Inventors: Jun KANO, Yokohama-shi, Kanagawa (JP); Hironori FUNAKOSHI, Yokohama-shi, Kanagawa (JP); Masatoshi YANASE, Yokosuka-shi, Kanagawa (JP); Tsubasa IMAMURA, Yokohama-shi, Kanagawa (JP)

(21) Appl. No.: 19/103,235

(22) PCT Filed: Aug. 3, 2023
(86) PCT No.: PCT/JP2023/028466

§ 371 Date: Feb. 12, 2025

(30) Foreign Application Priority Data
Aug. 23, 2022 (JP) 2022-132790

(51) Int. Cl. H04N 23/71; H04N 23/62; H04N 23/73

(52) U.S. Cl. CPC H04N 23/71; H04N 23/73; H04N 23/62

(57) ABSTRACT

An estimation method includes: acquiring a first image by setting image-capturing conditions of an image-capturing device to first conditions and then capturing a prescribed area; acquiring a second image by setting the image-capturing conditions of the image-capturing device to second conditions and then capturing the prescribed area; and estimating a characteristic of the first conditions based on a comparison of a characteristic of the first image and a characteristic of the second image.

### CROSS-REFERENCE TO RELATED APPLICATIONS

This application is a National Phase of International Application Number PCT/JP2023/028466 filed Aug. 3, 2023, and claims priority of Japanese Patent Application No. 2022-132790 (filed Aug. 23, 2022), the entire disclosure of which is hereby incorporated by reference.

### TECHNICAL FIELD

The present disclosure relates to an estimation method, an illumination control method, a non-transitory computer readable medium, a control device, and an illumination control system.

### BACKGROUND

A known system controls illumination by estimating an illuminance distribution based on an image captured by a camera (for example, see Patent Literature 1).

### CITATION LIST

### Patent Literature

Patent Literature 1: Japanese Unexamined Patent Application Publication No. 9-312198

### SUMMARY

In an embodiment of the present disclosure, an estimation method includes acquiring a first image by setting image-capturing conditions of an image-capturing device to first conditions and then capturing a prescribed area. The estimation method includes acquiring a second image by setting the image-capturing conditions of the image-capturing device to second conditions and then capturing the prescribed area. The estimation method includes estimating a characteristic of the first conditions based on a comparison of a characteristic of the first image and a characteristic of the second image.

In an embodiment of the present disclosure, an illumination control method may include controlling an illumination device installed in the prescribed area based on an estimated illuminance of the prescribed area obtained by performed the estimation method.

In an embodiment of the present disclosure, a non-transitory computer readable medium stores an estimation program. The illuminance estimation program is configured to cause a processor to acquire a first image by setting image-capturing conditions of an image-capturing device to first conditions and then capturing a prescribed area. The estimation program is configured to cause the processor to acquire a second image by setting the image-capturing conditions of the image-capturing device to second conditions and then capturing the prescribed area. The estimation program is configured to cause the processor to estimate a characteristic of the first conditions based on a comparison of a characteristic of the first image and a characteristic of the second image.

In an embodiment of the present disclosure, a control device includes a controller. The controller is configured to acquire a first image by setting image-capturing conditions of an image-capturing device to first conditions and then capturing a prescribed area. The controller is configured to acquire a second image by setting the image-capturing conditions of the image-capturing device to second conditions and then capturing the prescribed area. The controller is configured to estimate a characteristic of the first conditions based on a comparison of a characteristic of the first image and a characteristic of the second image.

In an embodiment of the present disclosure, an illumination control system includes: a control device; an illumination device configured to illuminate a prescribed area; and an image-capturing device configured to capture an image of the prescribed area. The control device is configured to acquire a first image by setting image-capturing conditions of an image-capturing device to first conditions and then capturing a prescribed area. The control device is configured to acquire a second image by setting the image-capturing conditions of the image-capturing device to second conditions and then capturing the prescribed area. The control device is configured to estimate a characteristic of the first conditions based on a comparison of a characteristic of the first image and a characteristic of the second image.

### BRIEF DESCRIPTION OF THE DRAWINGS

FIG. 1 is a block diagram illustrating an example configuration of an illumination control system according to an embodiment.

FIG. 2 is a schematic diagram illustrating an example configuration of an illumination control area.

FIG. 3 is a schematic diagram illustrating an example of the relationship between light incident on a desk and light reflected by the desk and traveling to an image-capturing device.

FIG. 4 is a diagram illustrating an example of a captured image.

FIG. 5 is a flowchart illustrating example procedures of an estimation method according to an embodiment.

FIG. 6 is a flowchart illustrating example procedures for estimating shutter speed.

FIG. 7 is a flowchart illustrating example procedures for detecting a deviation between a current value and an estimated value of shutter speed.

FIG. 8 is a flowchart illustrating example procedures for estimating an operation mode of an image-capturing device.

FIG. 9 is a graph illustrating an example of the relationship between estimated values and measured values of illuminance.

### DESCRIPTION OF EMBODIMENTS

The state of image-capturing devices such as cameras can affect the operation of systems. There is a demand to improve the stability of the operation of systems. In an embodiment of the present disclosure, an estimation method, an illumination control method, an estimation program, a control device, and an illumination control system can improve the stability of the operation of a system.

### Example Configuration of Illumination Control System 1

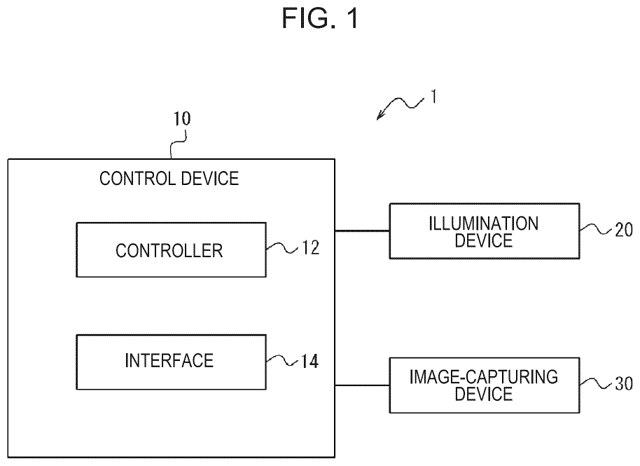

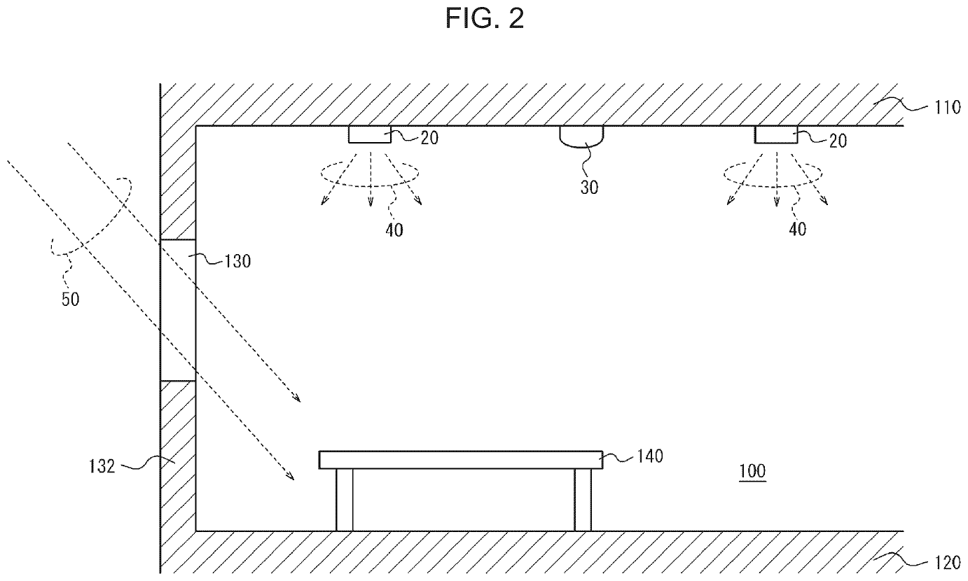

As illustrated in FIG. 1, in an embodiment, an illumination control system 1 includes a control device 10, illumination devices 20, and an image-capturing device 30. The illumination control system 1 controls illumination in an illumination control area 100 illustrated in FIG. 2. Examples of the illumination control area 100 may include various spaces for which illumination is to be controlled such as offices, conference rooms, or classrooms. The illumination control area 100 is a space enclosed by a ceiling 110, a floor 120, a window 130, and a wall 132. In the illumination control area 100, a desk 140 is placed on the floor 120. In this embodiment, the illumination devices 20 and the image-capturing device 30 are installed on the ceiling 110 of the illumination control area 100.

In the illumination control system 1, the control device 10 estimates the illuminance of the illumination control area 100 based on an image of the illumination control area 100 captured by the image-capturing device 30. The control device 10 controls the illumination devices 20 and controls the illuminance of the illumination control area 100 based on estimation results of the illuminance of the illumination control area 100.

Hereafter, an example configuration of each part of the illumination control system 1 is described.

### Control Device 10

The control device 10 includes a controller 12 and an interface 14. The controller 12 is configured to be able to control the illumination devices 20. The controller 12 may be configured to be able to control the image-capturing device 30. The controller 12 may include one or more processors. The processor can execute programs for realizing the various functions of the control device 10. The processors may be implemented as a single integrated circuit. An integrated circuit is also referred to as an IC. Processors may be implemented as multiple integrated circuits and discrete circuits connected so as to be able to communicate with each other. The processors may be realized based on various other known technologies.

The control device 10 may further include a storage unit. The storage unit may, for example, include an electromagnetic storage medium such as a magnetic disk, or may include a memory such as a semiconductor memory or a magnetic memory. The storage unit may store, for example, various information referred to during the operation of the control device 10 and programs for implementing the various functions of the control device 10. The storage unit may function as a working memory of the controller 12. The storage unit may be configured to be integrated with the controller 12, or may be configured to be separate from the controller 12.

The interface 14 may include a communication module that communicates with an external device such as the illumination devices 20 or the image-capturing device 30. The communication module may support mobile communication standards such as 4G (fourth Generation) or 5G (fifth Generation), for example. The communication module may support communication standards such as LAN (local area network). The communication module may support wired or wireless communication standards. The communication module may support various communication standards, including but not limited to the above examples. The interface 14 may be configured to be able to connect to an external communication module.

The interface 14 may include an input device that accepts inputs such as information or data from the user. The input device may include, for example, a touch panel or touch sensor or a pointing device such as a mouse. The input device may include physical keys. The input device may include an audio input device such as a microphone. The interface 14 may be configured to be connectable to an external input device.

The interface 14 may include an output device that outputs information, data, or the like to the user. The output device may include, for example, a display device that outputs visual information such as images or text or graphics. The display device may include, for example, an LCD (liquid crystal display), an organic EL (electro-luminescence) or inorganic EL display, or a PDP (plasma display panel). The display device is not limited to these displays and may include a display using any of a variety of other systems. The display device may include a light-emitting device such as an LED (light emitting diode) or an LD (laser diode). The display device may include various other devices. The output device may include an audio output device such as a speaker that outputs auditory information such as a voice.

The output device may include a vibration device such as a vibrator that outputs tactile information such as vibrations, for example. The output device is not limited to these examples and may include various other devices. The interface 14 may be configured to be connectable to an external output device.

### Illumination Device 20

Each illumination device 20 radiates illumination light 40. Examples of the illumination device 20 include various light sources, such as LEDs (light emitting diodes), semiconductor laser devices such as laser diodes, VCSELs (vertical cavity surface emitting lasers) or SLDs (super luminescent diodes). In this embodiment, the illumination device 20 is assumed to be configured as a glare-free downlight. A glare-free downlight is a light in which a light source structure or light reflecting mechanism is designed to reduce the glare of the radiated light in order to reduce unpleasant glare. A method used to evaluate unpleasant glare is described, for example, in JISZ9110: Shomei kijun sosoku (2010) or ISO8995: The lighting of indoor work systems (1989). The illumination device 20 may be configured in various other ways, not limited to a glare-free downlight.

The number of illumination devices 20 installed in the illumination control area 100 is not limited to two as illustrated in FIG. 2, and may be one, three, or more. When multiple illumination devices 20 are installed in the illumination control area 100, the illumination devices 20 may be configured so that the illumination devices 20 can be individually controlled to be turned on or off. The intensity of the illumination light 40 emitted by each illumination devices 20 may be individually controllable.

### Image-Capturing Device 30

The image-capturing device 30 captures an image of the illumination control area 100 and outputs the captured image to the control device 10. The image-capturing device 30 includes an image sensor that captures images electronically and is configured as a network camera, for example. The image-capturing device 30 may include a CCD (charge coupled device image sensor) or a CMOS (complementary metal oxide semiconductor) sensor as an image sensor.

### Example Operation of Illumination Control System 1

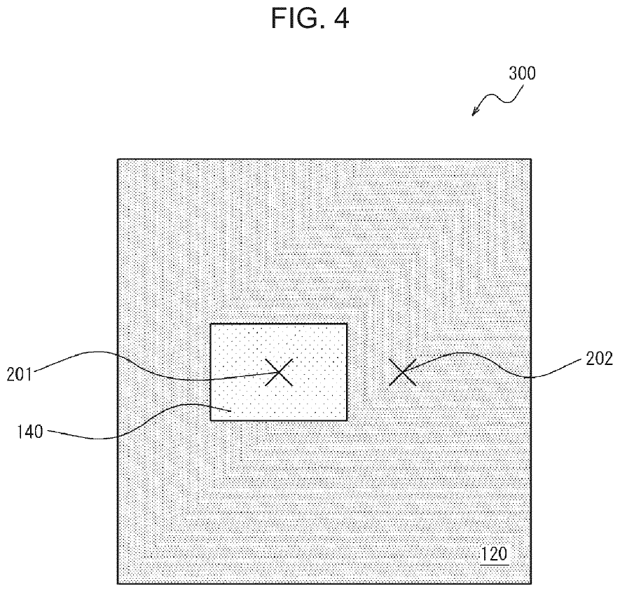

The illumination control system 1 controls the illuminance of the illumination control area 100. The illumination control area 100 is illuminated by the illumination light 40 emitted from the illumination devices 20 and outside light 50 entering through the window 130. In this case, the illuminance in each part of the illumination control area 100 is determined based on the intensity of the illumination light 40 reaching that part and the intensity of the outside light 50. The light reaching each part of the illumination control area 100 can include direct or indirect light. Direct light corresponds to the illumination light 40 or the outside light 50 arriving directly from the light source. Indirect light corresponds to light that arrives indirectly after the illumination light 40 or the outside light 50 has been reflected or scattered by other areas. In this embodiment, the intensity of indirect light is considered to be negligibly small compared to the intensity of direct light. Hereafter, an example of an operation for estimating illuminance based on an image captured by the image-capturing device 30 (see FIG. 4) will be described under the assumption that the illuminance of each part of the illumination control area 100 is determined by the intensity of the direct light of the illumination light 40 or the outside light 50.

### Correlation Between Brightness of Captured Image and Illuminance in Captured Region

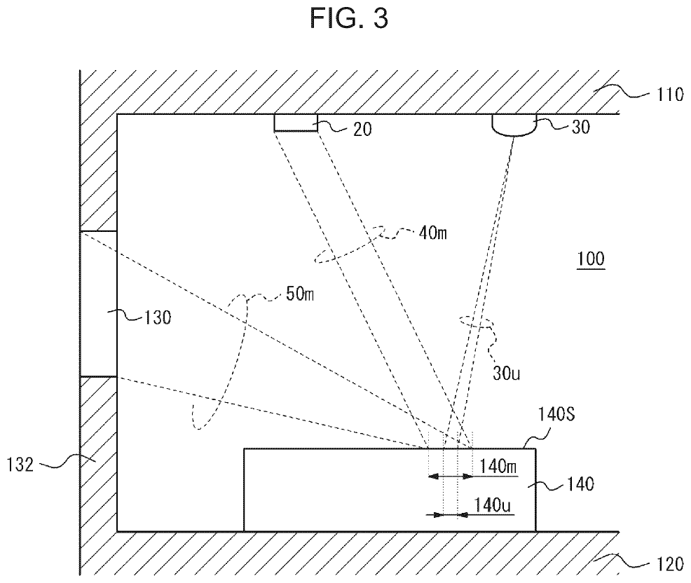

As illustrated in FIG. 3, light reaching a small region 140m of a top surface 140S of the desk 140 includes a partial component 40m of the illumination light 40 incident on the small region 140m from the illumination device 20 and a partial component 50m of the outside light 50 incident on the small region 140m from the window 130. Therefore, the illuminance in the small region 140m is determined based on the sum of the intensity of the partial component 40m of the illumination light 40 and the intensity of the partial component 50m of the outside light 50.

Here, the light incident on the small region 140m is assumed to be reflected according to the model of Lambert reflection. Lambert reflection is ideal diffuse reflection, also called perfect diffuse reflection. In the model of Lambert reflection, light incident on a flat surface is reflected in all directions. In the model of Lambert reflection, the intensity of light reflected in each direction from a flat surface is determined according to Lambert's cosine law in accordance with the angle between the normal to the plane and each direction. In other words, the intensity of light reflected in each direction from the flat surface is determined so that the brightness of the small region 140m is constant when viewed in any direction from the flat surface. This is because, for example, when the small region 140m is viewed from an inclined direction having an angle θ with respect to the normal of the flat surface, the intensity of the reflected light traveling in the inclined direction is cos θ times the intensity of the reflected light traveling in the normal direction of the flat surface. On the other hand, the area of the small region 140m viewed from the inclined direction is reduced to cos θ times the area of the small region 140m viewed from the normal direction. The brightness is calculated as the intensity of light per unit area. Therefore, assuming that reflection follows the model of Lambert reflection, the brightness of the small region 140m is constant when viewed from any direction relative to the flat surface.

A portion of the light reflected in the small region 140m travels toward the image-capturing device 30. In other words, the small region 140m is regarded as a surface light source when viewed from the image-capturing device 30. When the image-capturing device 30 captures an image of the small region 140m, one pixel in the image captured by the image-capturing device 30 corresponds to a partial region 140u included in the small region 140m. The light traveling from the partial region 140u toward the image-capturing device 30 is represented as image-capturing light 30u. The brightness of the pixel corresponding to the partial region 140u corresponds to the intensity of the image-capturing light 30u. Here, assuming that light incident on the small region 140m is reflected in accordance with the model of Lambert reflection, the brightness of the small region 140m is constant when viewed from any direction. In other words, the brightness of the small region 140m corresponds to the illuminance in the small region 140m when viewed from any direction. Therefore, in the image captured by the image-capturing device 30, the brightness of the pixel corresponding to the partial region 140u, which is included in the small region 140m, corresponds to the illuminance in the small region 140m.

As discussed above, assuming that light incident on the small region 140m is reflected in accordance with the model of Lambert reflection, the brightness of the pixel corresponding to the small region 140m in the image captured by the image-capturing device 30 corresponds to the illuminance of the small region 140m. Therefore, the controller 12 of the control device 10 can estimate the illuminance of the part corresponding to each pixel in the illumination control area 100 based on the brightness of the corresponding pixel in the image captured by the image-capturing device 30.

The intensity of the image-capturing light 30u traveling from the partial region 140u toward the image-capturing device 30 can be correlated with the illuminance in the small region 140m, even when the light incident on the small region 140m is not reflected according to the model of Lambert reflection. The controller 12 may acquire information identifying the correlation between the intensity of the image-capturing light 30u from the partial region 140u set at a prescribed position in the illumination control area 100 and the illuminance in the small region 140m that includes the partial region 140u.

For example, if the small region 140m is set as part of the top surface 140S of the desk 140, the controller 12 may identify the correlation between the illuminance of the top surface 140S and the intensity of the image-capturing light 30u based on characteristics such as the material, surface shape, or reflectance of the top surface 140S. The controller 12 may estimate the illuminance of the small region 140m based on the brightness of a captured image of the top surface 140S. As illustrated in FIG. 4, the controller 12 may set a grid 201 on a portion of the desk 140 captured in a target image 300, which is obtained by capturing a portion of the illumination control area 100 as an estimation target. The controller 12 may estimate the illuminance of the desk 140 corresponding to the grid 201 based on the brightness of the pixel where the grid 201 is set.

For example, if the small region 140m is set as a portion of the floor 120, the controller 12 may identify the correlation between the illuminance of the floor 120 and the intensity of the image-capturing light 30u based on characteristics such as the material, surface shape, or reflectance of the floor 120. The controller 12 may estimate the illuminance of the floor 120 based on the brightness of a captured image of the floor 120. The controller 12 may set a grid 202 on a portion of the floor 120 in the target image 300, as illustrated in FIG. 4. The controller 12 may estimate the illuminance of the floor 120 corresponding to the grid 202 based on the brightness of the pixel where the grid 202 is set.

### Relationship Between Image-Capturing Conditions of Captured Image and Brightness of Captured Image

The brightness of a captured image may vary depending on the image-capturing conditions at the time when the image-capturing device 30 captures the illumination control area 100. The image-capturing conditions of the image-capturing device 30 include shutter speed, aperture value, and ISO (international organization for standardization) sensitivity. For example, the faster the shutter speed, the shorter the time during which the image-capturing device 30 receives light using an image-capturing element. As a result, for the same amount of incident light, the higher the shutter speed, the lower the brightness of the captured image. The larger the aperture value, the smaller the amount of light incident on the image-capturing element. As a result, for the same amount of incident light, the larger the aperture value, the lower the brightness of the captured image. The higher the ISO sensitivity, the better the image-capturing element can detect even weak amounts of light. As a result, for the same amount of incident light, the higher the ISO sensitivity, the higher the brightness of the captured image.

When the image-capturing device 30 is a network camera, the aperture value and ISO sensitivity may be set to constant values. On the other hand, the shutter speed may be automatically adjusted in accordance with the brightness of a prescribed area such as the illumination control area 100. Here, let us assume that the aperture value and ISO sensitivity are set to constant values and the shutter speed is automatically adjusted in the image-capturing device 30. The brightness of the image captured by the image-capturing device 30 operating in this manner varies depending on the value of the shutter speed. Then, the relationship between the brightness of the captured image of the illumination control area 100 and the illuminance of the illumination control area 100 is determined in accordance with the value of the shutter speed. Therefore, the controller 12 of the control device 10 needs to obtain the value of the shutter speed at the time when the image-capturing device 30 captured the image of the illumination control area 100 in order to estimate the illuminance based on the brightness of the captured image.

### Estimation of Value of Shutter Speed

Here, the image-capturing device 30 outputs the captured image but might not output the value of the automatically adjusted shutter speed. In other words, when the controller 12 acquires a captured image from the image-capturing device 30, the controller 12 may not be able to acquire the value of the shutter speed from when the image was captured. In this embodiment, the controller 12 of the control device 10 is configured to estimate the value of the shutter speed even when the value of the shutter speed cannot be acquired from the image-capturing device 30. An example of an operation of estimating the value of the shutter speed is described below.

The image-capturing device 30 can operate with either a shutter speed mode set to automatic or the shutter speed mode set to manual. The image-capturing device 30 automatically adjusts the value of the shutter speed when the shutter speed mode is set to automatic. When the shutter speed mode is set to manual, the image-capturing device 30 sets the value of the shutter speed to a value specified by the controller 12. The controller 12 specifies the value of the shutter speed so that the difference between the brightness of an image captured with the shutter speed mode set to automatic and the brightness of an image captured with the shutter speed mode set to manual becomes small. When the absolute value of the difference between the brightness of the image captured with the shutter speed mode set to automatic and the brightness of the image captured with the shutter speed mode set to manual becomes less than a prescribed threshold, the value of the shutter speed with the shutter speed mode set to manual is assumed to be the value of the shutter speed automatically adjusted by the image-capturing device 30 with the shutter speed mode set to automatic.

The controller 12 may, for example, set the estimated value of the shutter speed to a tentative value. The estimated value of the shutter speed set as a tentative value is also referred to as a tentative estimated value of the shutter speed. The controller 12 may, for example, determine a value halfway between an upper limit and a lower limit of the shutter speed of the image-capturing device 30 as a tentative estimated value.

The controller 12 operates the image-capturing device 30 with the shutter speed mode of the image-capturing device 30 set to automatic, acquires an image A captured by the image-capturing device 30 once the shutter speed has stabilized, and calculates an average brightness A of the image A. The controller 12 operates the image-capturing device 30 with the shutter speed mode of the image-capturing device 30 set to manual and a tentative estimated value specified as the shutter speed, acquires an image B captured by the image-capturing device 30 with the tentative estimated value set as the shutter speed, and calculates an average brightness B of the image B.

If the absolute value of the difference between the average brightness A and the average brightness B is less than a prescribed threshold, the controller 12 estimates that the shutter speed when the image was captured with the shutter speed mode of the image-capturing device 30 set to automatic was the tentative estimated value. In other words, the controller 12 determines the tentative estimated value as the estimated value of the shutter speed.

If the absolute value of the difference between the average brightness A and the average brightness B is greater than or equal to the prescribed threshold, the controller 12 changes the tentative estimated value. If the average brightness B is higher than the average brightness A, the controller 12 changes the tentative estimated value so as to increase the shutter speed (shorten the shutter release time). If the average brightness B is lower than the average brightness A, the controller 12 changes the tentative estimated value so as to decrease the shutter speed (lengthen the shutter release time).

The controller 12 reacquires the image A captured with the shutter speed mode of the image-capturing device 30 set to automatic and the image B captured with the shutter speed mode of the image-capturing device 30 set to manual and the changed tentative estimated value specified as the shutter speed. The controller 12 repeatedly changes the tentative estimated value until the absolute value of the difference between the average brightness A of the image A and the average brightness B of the image B is less than the prescribed threshold. The controller 12 may use various methods, such as a binary tree search method, as an algorithm for changing the tentative estimated value.

When comparing the brightness of the image A and the brightness of the image B, the controller 12 may calculate the average of the brightnesses of all the pixels in each image as an average brightness or may calculate the average of the brightnesses of some pixels in each image as an average brightness. The controller 12 may compare the brightness of each pixel in the image A with the brightness of the corresponding pixel in the image B. The controller 12 may calculate the difference between the brightness of each pixel in the whole or part of the image A and the brightness of the corresponding pixel in the whole or part of the image B, and compare the brightness of the image A to the brightness of the image B based on the average value of the differences of the brightnesses of corresponding pixels.

The brightness of a prescribed area, such as the illumination control area 100, may vary due to, for example, the illumination devices 20 being turned on or off, or blinds or curtains on the windows 130 being open or closed. The shutter speed, which is automatically adjusted by the image-capturing device 30, varies depending on variations in brightness of the prescribed area. After determining an estimated value of the shutter speed, the controller 12 may update the estimated value in accordance with variations in the shutter speed.

Specifically, the controller 12 may acquire the image A captured with the shutter speed mode of the image-capturing device 30 set to automatic and the image B captured with the shutter speed mode of the image-capturing device 30 set to manual and the determined estimated value specified as the shutter speed. If the absolute value of the difference between the average brightness A of the image A and the average brightness B of the image B is greater than or equal to the prescribed threshold, the controller 12 may consider the determined estimated value as a tentative estimated value and redetermine the estimated value.

### Example Operation of Estimation of Illuminance

The controller 12 of the control device 10 can estimate the illuminance of the illumination control area 100 based on an image of the illumination control area 100 captured with the shutter speed mode of the image-capturing device 30 set to automatic and an estimated value of the shutter speed at the time when the image was captured. Hereafter, a specific example operation of estimating illuminance will be described.

The controller 12 acquires a captured image from the image-capturing device 30. The captured image is assumed to be represented by data in a first format. The first format may be, but is not limited to, sRGB, for example.

The controller 12 may convert the data of the captured image to data of a second format that includes lightness as a parameter. The second format may be, for example, the CIE (Commission Internationale de l'Eclairage) 1976 L*a*b* color space. The CIE 1976 L*a*b* color space is one of the color spaces (complementary color spaces) used in various fields to represent the colors of objects. In the CIE 1976 L*a*b* color space, image data is represented using lightness L* and chromaticity a* and b* as parameters. The second format is not limited to the CIE 1976 L*a*b* color space described above, and may be various other formats.

The controller 12 extracts pixels in the captured image that represent a target region for which the illuminance is to be estimated. The controller 12 may correct the lightness L* of the extracted pixels by multiplying the lightness L* by a factor based on an estimated value of the shutter speed. The controller 12 may use the shutter speed itself as a factor to multiply the lightness L* by in order to correct the lightness L*.

The controller 12 may estimate the illuminance of the target region based on the corrected lightness. For example, the controller 12 may determine the illuminance corresponding to the corrected lightness as an estimated value from a table or a relational formula etc. representing the relationship between lightness and illuminance.

The controller 12 may estimate the illuminance of the target region based on the data of pixels representing the target region for which illuminance is to be estimated using the data of the captured image in the first format as is. The controller 12 may convert the data of the captured image to data of a third format that does not include lightness as a parameter, and estimate the illuminance of the target region based on the data of pixels representing the target region for which the illuminance is to be estimated.

### Estimation of Night Mode

The image-capturing device 30 may be operating in night mode when a prescribed area such as the illumination control area 100 is dark. When operating in the night mode, the image-capturing device 30 can use IR (infrared) lamps or IR LEDs (light emitting diodes) to emit infrared light to capture movement of people etc. in a dark prescribed area. The image-capturing device 30 can function as a motion sensor by operating in a night mode.

Here, if the illumination control area 100 is dark, the controller 12 of the control device 10 does not need to estimate the illuminance of the illumination control area 100. In response to acquiring information indicating that the image-capturing device 30 is operating in the night mode, the controller 12 can stop the operation of estimating the illuminance of the illumination control area 100 or reduce the frame rate of the image-capturing device 30.

However, the image-capturing device 30 may not have a function of outputting the fact that the image-capturing device 30 is operating in night mode. In other words, the controller 12 may not be able to acquire information from the image-capturing device 30 indicating that the image-capturing device 30 is operating in the night mode.

Accordingly, the controller 12 may estimate whether the image-capturing device 30 is operating in the night mode. When the image-capturing device 30 is operating in the night mode, the shutter speed is slowed down in automatic shutter speed adjustment so that the light-receiving element can receive sufficient light from the dark prescribed area. Let us assume that the value of shutter speed is expressed as a smaller value for slower shutter speeds. In other words, the slower the shutter speed, the smaller the value of the shutter speed will be. For example, the controller 12 may estimate that the image-capturing device 30 is operating in the night mode when the estimated value of the shutter speed of the image-capturing device 30 is less than a prescribed speed. For example, the controller 12 may estimate that the image-capturing device 30 is operating in a mode other than the night mode when the estimated value of the shutter speed of the image-capturing device 30 is greater than or equal to the prescribed speed.

If the estimated value of the shutter speed fluctuates in small increments between a value greater than the prescribed speed and a value less than the prescribed speed, the estimation result of the operation mode of the image-capturing device 30 acquired by the controller 12 may fluctuate in small increments. As a result, operation of the controller 12 may become unstable. Therefore, the controller 12 may vary the threshold for estimating that the operation of the image-capturing device 30 has transitioned to the night mode or the threshold for estimating that the operation of the image-capturing device 30 has transitioned from the night mode to another mode (i.e., has been released from the night mode). The threshold for estimating that the operation of the image-capturing device 30 has transitioned to the night mode is also referred to as a setting threshold. The threshold for estimating that the operation of the image-capturing device 30 has transitioned from the night mode to another mode (i.e., has been released from the night mode) is also referred to as a release threshold. The controller 12 may estimate that the operation of the image-capturing device 30 has transitioned to the night mode when the estimated value of the shutter speed is less than the setting threshold. The controller 12 may estimate that the operation of the image-capturing device 30 has been released from the night mode when the estimated value of the shutter speed is greater than or equal to the release threshold. Due to the setting threshold being smaller than the release threshold, the estimation of the operation mode of the image-capturing device 30 by the controller 12 can be stabilized.

The controller 12 may estimate that the illumination control area 100 is dark due to the shutter speed of the image-capturing device 30 being slow, regardless of whether the image-capturing device 30 is operating in the night mode. The controller 12 may estimate whether the illumination control area 100 is transitioning to a state that is dark enough not to require estimation of the illuminance thereof or a state that is bright enough to require estimation of the illuminance thereof. A state in which the illumination control area 100 is dark enough to not require estimation of the illuminance thereof corresponds to a state in which the image-capturing device 30 is operating in the night mode. A state in which the illumination control area 100 is bright enough to require estimation of the illuminance thereof corresponds to a state in which the image-capturing device 30 is operating in a mode other than the night mode. The controller 12 may estimate that the illumination control area 100 is in a dark state when the estimated value of the shutter speed is less than the setting threshold. The controller 12 may estimate that the illumination control area 100 is in a bright state when the estimated value of the shutter speed is greater than or equal to than the release threshold. When controller 12 estimates that the illumination control area 100 is in a dark state, the controller 12 may stop estimating the illuminance of the illumination control area 100 or reduce the frame rate of the image-capturing device 30.

The operation modes of the image-capturing device 30 are not limited to the night mode, and the controller 12 may estimate whether the image-capturing device 30 is operating in various other operation modes, such as a holiday mode. In other words, the controller 12 may determine whether the image-capturing device 30 is operating in a prescribed mode.

Prescribed modes may include a night mode or a holiday mode, or various other operation modes. When the controller 12 determines that the image-capturing device 30 is operating in a prescribed mode, the controller 12 may stop estimating the illuminance of the illumination control area 100 or reduce the frame rate of the image-capturing device 30.

### Control of Illumination Device 20

The controller 12 of the control device 10 may control the illumination devices 20 based on estimation results of the illuminance in each region of the illumination control area 100. For example, the controller 12 estimates the illuminance in a prescribed region illuminated by the illumination devices 20 disposed in the illumination control area 100.

Based on the estimation results of illuminance of the prescribed region, the controller 12 controls the turning on or off of the illumination devices 20 illuminating the prescribed region or controls the intensity of the illumination light 40 emitted by the illumination devices 20 toward the prescribed region.

The controller 12 may control glare-free downlights as the illumination devices 20. As mentioned above, the glare-free downlights limit the effect of uncomfortable glare.

Therefore, the extent to which the illumination light 40 emitted from the illumination devices 20 causes discomfort to people due to glare is limited. As a result, the comfort of people in the illumination control area 100 can be improved.

### Example Procedure of Estimation Method

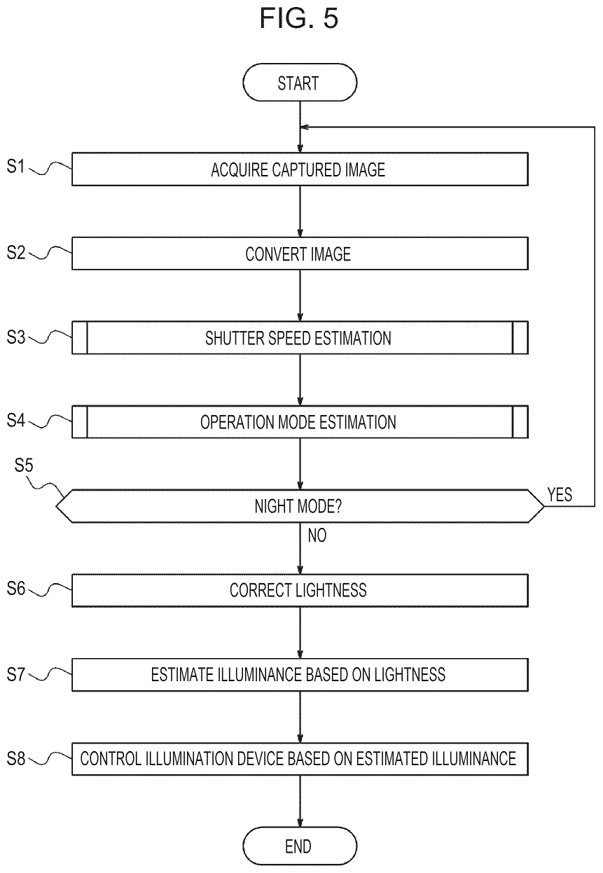

The controller 12 of the control device 10 may execute an illuminance estimation method and an illumination control method including the procedures of the flowchart illustrated in FIG. 5. The illuminance estimation method and the illumination control method may be realized as an illuminance estimation program and an illumination control program to be executed by a processor including the controller 12. The illuminance estimation program and the illumination control program may be stored on a non-transitory computer readable medium.

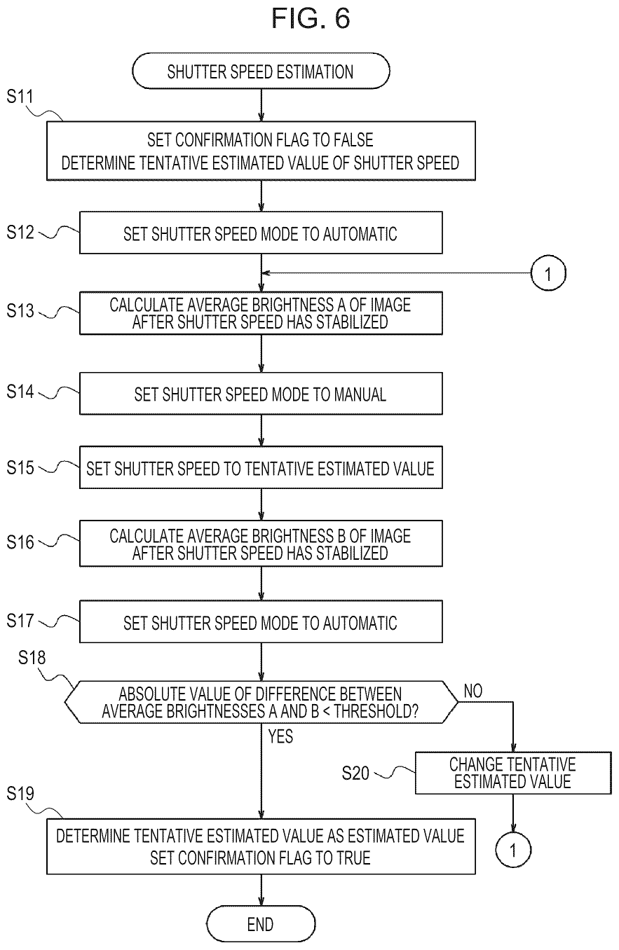

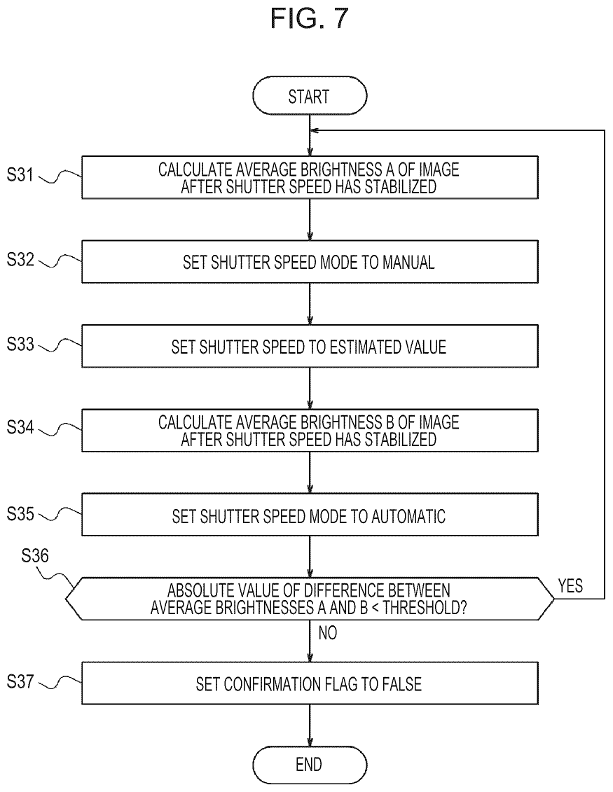

The controller 12 acquires a captured image from the image-capturing device 30 (Step S1). The controller 12 converts the format of the captured image from the first format to the second format (Step S2). The controller 12 estimates the shutter speed of the image-capturing device 30 (Step S3). The procedure for estimating the shutter speed is described below based on the procedures illustrated as flowcharts in FIG. 6 and FIG. 7.

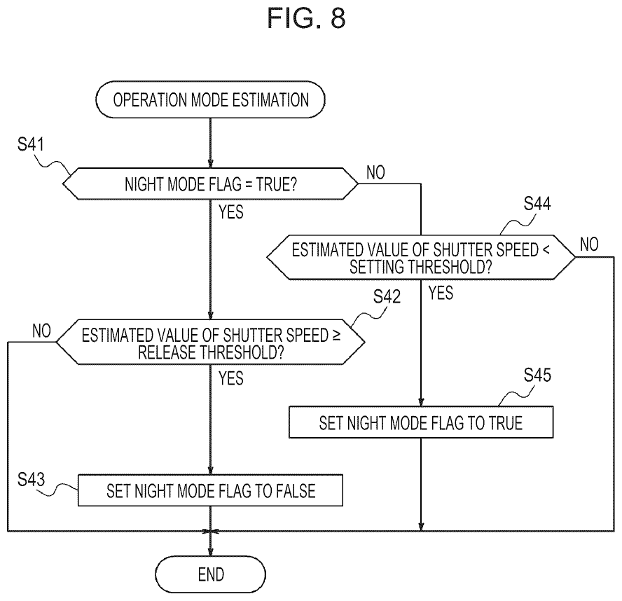

The controller 12 estimates the operation mode of the image-capturing device 30 (Step S4). The procedure for estimating the operation mode is described below based on the procedures illustrated as a flowchart in FIG. 8. The controller 12 determines whether the operation mode of the image-capturing device 30 is estimated to be the night mode (Step S5). When the controller 12 estimates that the operation of the image-capturing device 30 is the night mode (Step S5: YES), the controller 12 does not proceed to the procedure for estimating the illuminance in Step S6 and steps thereafter, but rather returns to the procedure in Step S1.

When the controller 12 estimates that the operation of the image-capturing device 30 is not the night mode (Step S5: NO), the controller 12 corrects the lightness of the captured image (Step S6) based on the estimated value of the shutter speed acquired in the procedure in Step S3. The controller 12 estimates the illuminance of a target region based on the lightness of the pixels, in the lightness-corrected captured image, representing the target region for which illuminance is to be estimated (Step S7). The controller 12 controls the illumination device 20 that illuminates the target region based on the estimated illuminance of the target region (Step S8). After executing the procedure of Step S8, the controller 12 completes execution of the procedures of the flowchart in FIG. 5.

The controller 12 may perform the procedure of estimating the shutter speed in Step S3 or the procedure of estimating the operation mode of the image-capturing device 30 in Step S4 regardless of the order of the procedures in the flowchart in FIG. 5. The controller 12 may perform the procedure of estimating the operation mode of the image-capturing device 30 in Step S4, for example, when a polling time has elapsed. The controller 12 may perform the procedure of estimating the shutter speed in Step S3 in parallel with the procedure of acquiring a captured image in Step S1, for example. In the procedure of converting the captured image in Step S2, the controller 12 may convert the captured image acquired for the purpose of estimating the shutter speed and use the converted captured image to estimate the illuminance.

### Procedure for Estimating Shutter Speed

The controller 12 may perform a shutter speed estimation method including the procedures of the flowchart illustrated in FIG. 6 in order to estimate the shutter speed. The shutter speed estimation method may be realized as a stutter speed estimation program to be executed by a processor constituting the controller 12. The shutter speed estimation program may be stored on a non-transitory computer readable medium.

The controller 12 sets a confirmation flag, which indicates whether the estimated value of the shutter speed has been confirmed, to False, and determines a tentative estimated value of the shutter speed (Step S11). Here, when the confirmation flag is False, the confirmation flag indicates that the estimated value of the shutter speed has not been confirmed, and when the confirmation flag is True, the confirmation flag indicates that the estimated value of the shutter speed has been confirmed.

The controller 12 sets the shutter speed mode of the image-capturing device 30 to automatic (Step S12). The controller 12 acquires the image A captured by the image-capturing device 30 after the shutter speed has been automatically adjusted and stabilized, and calculates the average brightness A of the image A (Step S13).

The controller 12 sets the shutter speed mode of the image-capturing device 30 to manual (Step S14). The controller 12 sets a manually set value of the shutter speed of the image-capturing device 30 to a tentative estimated value (Step S15). The controller 12 acquires the image B captured by the image-capturing device 30 after the shutter speed has been set to the tentative estimated value and stabilized, and calculates the average brightness B of the image B (Step S16). The controller 12 sets the shutter speed mode of the image-capturing device 30 to automatic (Step S17).

The controller 12 determines whether the absolute value of the difference between the average brightness A calculated in Step S13 and the average brightness B calculated in Step S16 is less than a prescribed threshold (Step S18). When the absolute value of the difference in average brightness is less than the prescribed threshold (Step S18: YES), the controller 12 determines the tentative estimated value of the shutter speed as the estimated value of the shutter speed and sets the confirmation flag to True (Step S19). After executing the procedure of Step S19, the controller 12 completes execution of the procedures of the flowchart in FIG. 6. Once the controller 12 has executed the procedure of the flowchart in FIG. 6 as the procedure of Step S3 of the flowchart in FIG. 5, the controller 12 returns to the procedure of Step S4 of the flowchart in FIG. 5 after completing the execution of the procedure of the flowchart in FIG. 6.

When the absolute value of the difference in average brightness is not less than the prescribed threshold (Step S18: NO), i.e., when the absolute value of the difference in average brightness is greater than or equal to the prescribed threshold, the controller 12 changes the tentative estimated value of the shutter speed (Step S20). After execution of the procedure of Step S20, the controller 12 returns to the procedure of Step S13.

After determining the estimated value of the shutter speed, the controller 12 may perform the procedures of the flowchart illustrated in FIG. 7 in order to check whether the estimated value of the shutter speed deviates from the actual shutter speed due to variations in the brightness of the illumination control area 100.

With the shutter speed mode of the image-capturing device 30 set to automatic, the controller 12 acquires the image A captured by the image-capturing device 30 after the shutter speed has been automatically adjusted and stabilized, and calculates the average brightness A of the image A (Step S31). The controller 12 sets the shutter speed mode of the image-capturing device 30 to manual (Step S32). The controller 12 sets the manually set value of the shutter speed of the image-capturing device 30 to the estimated value determined in the procedure of Step S19 in FIG. 6 (Step S33). The controller 12 acquires the image B captured by the image-capturing device 30 after the shutter speed has been set to the estimated value and stabilized, and calculates the average brightness B of the image B (Step S34). The controller 12 sets the shutter speed mode of the image-capturing device 30 to automatic (Step S35).

The controller 12 determines whether the absolute value of the difference between the average brightness A calculated in Step S31 and the average brightness B calculated in Step S34 is less than a prescribed threshold (Step S36). When the absolute value of the difference in average brightness is less than the prescribed threshold (Step S36: YES), the controller 12 assumes that the estimated value of the shutter speed does not deviate from the actual shutter speed and returns to the procedure in Step S31. When the absolute value of the difference in average brightness is not less than the prescribed threshold (Step S36: NO), i.e., when the absolute value of the difference in average brightness is greater than or equal to the prescribed threshold, the controller 12 assumes that the estimated value of the shutter speed does deviate from the actual shutter speed and sets the confirmation flag to False (Step S37). After executing the procedure of Step S37, the controller 12 completes execution of the procedures of the flowchart in FIG. 7. After the controller 12 sets the confirmation flag to False in the procedure of Step S37, the controller 12 may proceed to the procedure of determining the tentative estimated value of the shutter speed in Step S11 of FIG. 6 and repeat the procedure of estimating the shutter speed.

### Example of Procedure of Estimating Operation Mode of Image-Capturing Device 30

In order to estimate the operation mode of the image-capturing device 30, the controller 12 may execute an operation mode estimation method including the procedures of the flowchart illustrated in FIG. 8. The operation mode estimation method may be realized as an operation mode estimation program to be executed by a processor constituting the controller 12. The operation mode estimation program may be stored on a non-transitory computer readable medium.

The controller 12 determines whether a night mode flag is set to True (Step S41). Here, when the night mode flag is True, the night mode flag indicates that the operation mode of the image-capturing device 30 is presumed to be the night mode, and when the night mode flag is False, the night mode flag indicates that the operation mode of the image-capturing device 30 is presumed not to be the night mode.

When the night mode flag is set to True (Step S41: YES), the controller 12 determines whether the estimated value of the shutter speed is greater than or equal to a release threshold (Step S42). When the estimated value of the shutter speed is greater than or equal to the release threshold (Step S42: YES), the controller 12 sets the night mode flag to False (Step S43). After execution of the procedure of Step S43, the controller 12 completes execution of the procedures of the flowchart in FIG. 8. When the estimated value of the shutter speed is not greater than or equal to the release threshold (Step S42: NO), i.e., when the estimated value of the shutter speed is less than the release threshold, the controller 12 completes the execution of the procedures of the flowchart in FIG. 8 without changing the night mode flag.

When the night mode flag is not set to True (Step S41: NO), i.e., when the night mode flag is set to False, the controller 12 determines whether the estimated value of the shutter speed is less than the setting threshold (Step S44). When the estimated value of the shutter speed is less than the setting threshold (Step S44: YES), the controller 12 sets the night mode flag to True (Step S45). After execution of the procedure of Step S45, the controller 12 completes execution of the procedures of the flowchart in FIG. 8. When the estimated value of the shutter speed is not less than the setting threshold (Step S44: NO), i.e., when the estimated value of the shutter speed is greater than or equal to the setting threshold, the controller 12 completes the execution of the procedures of the flowchart in FIG. 8 without changing the night mode flag.

### Summary

As described above, in the illumination control system 1, the control device 10, and the estimation method executed by the control device 10 according to this embodiment, the shutter speed of the image-capturing device 30 is estimated with the shutter speed mode set to automatic. The illuminance of the illumination control area 100 is estimated based on the estimated value of the shutter speed. In this way, the estimation accuracy of illuminance can be improved.

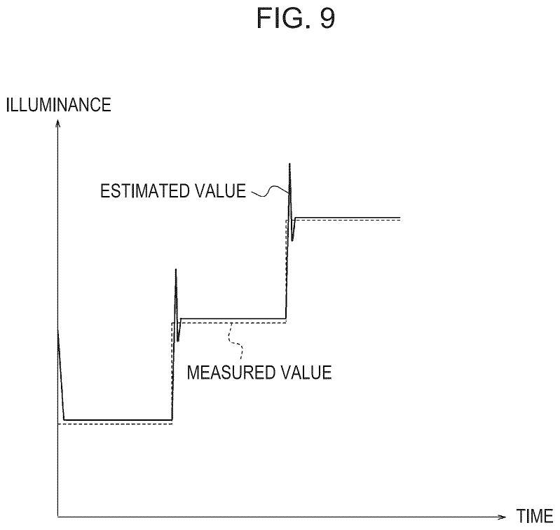

The graph in FIG. 9 illustrates an example of the relationship between the value of illuminance estimated by the controller 12 of the control device 10 according to this embodiment (estimated value) and the value of illuminance measured in the illumination control area 100 (measured value) by an illuminance sensor or another device. In the graph in FIG. 9, the horizontal axis represents time. The vertical axis represents the estimated value or the measured value of illuminance. The graph illustrated by a dashed line represents the measured values of illuminance. The graph illustrated by a solid line represents the estimated values of illuminance. The estimated values of illuminance overshoot or undershoot the measured values immediately after the illuminance (measured value) of the illumination control area 100 changes. However, the estimated value of illuminance follows the measured value during the period in which the illuminance (measured value) of the illumination control area 100 is stable. In other words, illuminance is estimated with high accuracy.

The control device 10 controls the illumination device 20 based on the estimation results of the illuminance of the illumination control area 100. In this way, the illuminance of the illumination control area 100 can be controlled with high accuracy.

### Other Embodiments

The illumination control system 1, the control device 10, the estimation method, or the illumination control method according to other embodiments will be described below.

### Other Examples of Estimation Targets as Image-Capturing Conditions

In the embodiment described above, the shutter speed mode, in which the shutter speed among the image-capturing conditions of the image-capturing device 30 is set, was set to automatic. Among the image-capturing conditions of the image-capturing device 30, an aperture mode, in which the aperture is set, or a sensitivity mode, in which ISO sensitivity is set, may be set to automatic.

When the aperture mode is set to automatic, the controller 12 of the control device 10 may estimate the aperture value. The controller 12 may correct the lightness based on the estimated value of the aperture value. When the sensitivity mode is set to automatic, the controller 12 may estimate the value of ISO sensitivity. The controller 12 may correct the lightness based on the estimated value of the ISO sensitivity.

In an embodiment, in the illumination control system 1, the image-capturing device 30 may be configured to automatically set at least one of the shutter speed, the aperture value, or the ISO sensitivity. The controller 12 may be configured to estimate at least one of the shutter speed, the aperture value, or the ISO sensitivity of the image-capturing device 30. In other words, the controller 12 may be configured to estimate at least one of the image-capturing conditions of the image-capturing device 30.

When at least one of the image-capturing conditions is set to automatic, the controller 12 may perform the following procedure in order to estimate an automatically adjusted value for the condition that is set to automatic. The combination of values of the image-capturing conditions is also referred to as the characteristics of the image-capturing conditions.

The controller 12 sets the image-capturing conditions of the image-capturing device 30 to first conditions. The first conditions correspond to conditions in which the image-capturing device 30 automatically adjusts at least one of the image-capturing conditions. The controller 12 acquires, as a first image, an image of a prescribed area captured by the image-capturing device 30 with the image-capturing conditions set to the first conditions. The controller 12 sets the image-capturing conditions of the image-capturing device 30 to second conditions. The second conditions correspond to conditions in which all the image-capturing conditions are manually set. The controller 12 acquires, as a second image, an image of a prescribed area captured by the image-capturing device 30 with the image-capturing conditions set to the second conditions.

The controller 12 estimates characteristics of the first conditions based on a comparison of characteristics of the first image and characteristics of the second image. The controller 12 may compare the brightness of each image as a characteristic of each image. The controller 12 may compare the lightness or chromaticity of each image as a characteristic of each image. As the characteristics of each image, the controller 12 may compare various characteristics of each image, not limited to these examples. The controller 12 acquires the second image while changing the second conditions so that the difference between the characteristics of the first image and the characteristics of the second image becomes smaller. The controller 12 may estimate the characteristics of the second conditions applied in order to acquire the second image as the characteristics of the first conditions when the value representing the differences between the characteristics of the first image and the characteristics of the second image are less than a prescribed value. The characteristics of the first conditions include the values of conditions automatically adjusted by the image-capturing device 30. Therefore, the controller 12 can estimate values automatically adjusted by the image-capturing device 30 for the conditions set to automatic based on a comparison between the characteristics of the first image and the characteristics of the second image.

In the case of estimating the shutter speed automatically adjusted by the image-capturing device 30, the first conditions correspond to conditions in which the shutter speed mode is set to automatic and the aperture mode and sensitivity mode are set to manual. Let us assume that with the aperture mode and sensitivity mode set to manual, the aperture value and ISO sensitivity are set to fixed conditions. The second conditions correspond to conditions in which the shutter speed mode is set to manual while the aperture mode and sensitivity mode are set to manual. Let us assume that the shutter speed is set to a prescribed value. Other than the shutter speed, let us assume that the aperture value and ISO sensitivity are set to fixed conditions. The controller 12 may compare the brightness of the first image with the brightness of the second image, as a characteristic of the first conditions, in order to estimate the automatically adjusted value of the shutter speed when the first image was captured.

The controller 12 may acquire, as a third image, an image of a prescribed area captured by the image-capturing device 30 with the image-capturing conditions of the image-capturing device 30 set to the first conditions. The controller 12 may estimate the illuminance of the prescribed area based on the estimation results of the characteristics of the first conditions and the characteristics of the third image.

The controller 12 may set the image-capturing conditions so that the aperture or ISO sensitivity is automatically adjusted. The controller 12 may correct the lightness based on the estimated value of the aperture or ISO sensitivity. The controller 12 may estimate the automatically adjusted values of the shutter speed, aperture, and ISO sensitivity, and correct the lightness based on the estimated values. The controller 12 may estimate the values of the image-capturing conditions and correct the lightness based on the estimated results of the values of the condition in order to match the brightness of the image captured by automatically adjusting each condition, regardless of the balance of the values of the image-capturing conditions.

### Other Uses of Estimated Values of Each Image-Capturing Condition

In the embodiment described above, the controller 12 of the control device 10 estimates the illuminance of the illumination control area 100 based on the estimated value of at least one of the image-capturing conditions, such as the shutter speed, aperture value, or ISO sensitivity, and the captured image of the illumination control area 100. The controller 12 may use the estimated value of at least one of the image-capturing conditions for a use other than estimation of illuminance. For example, the controller 12 may check the state of the image-capturing device 30 based on the estimated value of at least one of the image-capturing conditions. The controller 12 may diagnose whether the operation of the image-capturing device 30 is normal based on an estimation result of the illuminance of the illumination control area 100 measured by an illuminance sensor or another device and the estimated value of at least one of the image-capturing conditions of the image-capturing device 30.

As discussed above, by estimating at least one of the image-capturing conditions, the illumination device 20 can be controlled or the operation of the captured image-capturing device 30 can be checked or diagnosed. As a result, the stability of the operation of the illumination control system 1 can be improved.

### Separation of Components Contributing to Illuminance

The controller 12 of the control device 10 may separately estimate the illuminance in the illumination control area 100 for the illuminance contributed by the illumination light 40 and the illuminance contributed by the outside light 50. For example, the controller 12 may calculate the proportion of the lightness L* of the captured image that is contributed by the illumination light 40 and the proportion of the lightness L* of the captured image that is contributed by the outside light 50 based on the values of the chromaticity a* and b* of the captured image. The controller 12 may estimate the illuminance contributed by the illumination light 40 based on the lightness L* contributed by the illumination light 40, and the illuminance contributed by the outside light 50 based on the lightness L* contributed by the outside light 50. The controller 12 may calculate the estimated value of illuminance by weighting and summing the estimated values of illuminance contributed by each type of light.

The light that contributes to the illuminance of the illumination control area 100 is not limited to the illumination light 40 or the outside light 50, and may include a variety of other types of light.

The drawings illustrating the embodiments of the present disclosure are schematic drawings. The dimensional proportions and so on in the drawings do not necessarily match the actual dimensional proportions and so on.

A variety of variations and modifications may be made to the content of the present disclosure based on the present disclosure by one skilled in the art. Please note that, therefore, these variations or modifications are included within the scope of the present disclosure. For example, in each embodiment, each functional part, each means, each step and so on can be added to other embodiments so long as there are no logical inconsistencies, or can be replaced with each functional part, each means, each step, and so on of other embodiments. In each embodiment, a plurality of each functional part, each means, each step, and so on can be combined into a single functional part, means, or step or divided into multiple functional parts, means, or steps. Each of the above-described embodiments of the present disclosure is not limited to faithful implementation of each of the described embodiments, and may be implemented by combining or omitting some of the features as appropriate.

In the present disclosure, “first”, “second”, and so on are identifiers used to distinguish between such configurations. Regarding the configurations, “first”, “second”, and so on used to distinguish between the configurations in the present disclosure may be exchanged with each other. For example, identifiers “first” and “second” may be exchanged between the first conditions and the second conditions. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.
In an embodiment, (1) an estimation method includes: acquiring a first image by setting image-capturing conditions of an image-capturing device to first conditions and then capturing a prescribed area; acquiring a second image by setting the image-capturing conditions of the image-capturing device to second conditions and then capturing the prescribed area; and estimating a characteristic of the first conditions based on a comparison of a characteristic of the first image and a characteristic of the second image.
(2) The estimation method of (1) above may further include: setting a shutter speed to automatic adjustment and setting a condition other than the shutter speed to a fixed condition as the first conditions; setting the shutter speed to a prescribed value and setting the condition other than the shutter speed to the fixed condition as the second conditions; comparing brightnesses of the first image and the second image as the characteristics of the first image and the second image; and estimating an automatically adjusted value of the shutter speed when the first image is captured as the characteristic of the first conditions set as the image-capturing conditions of the image-capturing device.
(3) The estimation method of (1) or (2) above may further include: estimating an illuminance of the prescribed area based on a result of estimating the characteristic of the first conditions and a characteristic of a third image capturing the prescribed area with the image-capturing conditions of the image-capturing device set to the first conditions.
(4) The estimation method of (3) above may further include: determining whether the image-capturing device is operating in a prescribed mode based on the result of estimating the characteristic of the first conditions; and when the image-capturing device is determined to be operating in the prescribed mode, reducing a frame rate at which the prescribed area is captured or stopping estimation of the illuminance of the prescribed area.
In an embodiment, (5) an illumination control method may include: controlling an illumination device installed in the prescribed area based on an estimated illuminance of the prescribed area obtained by performed the estimation method of (3) or (4) above.
(6) The illumination control method of (5) above may include: controlling a glare-free downlight as the illumination device.
In an embodiment, (7) an estimation program is configured to cause a processor to: acquire a first image by setting image-capturing conditions of an image-capturing device to first conditions and then capturing a prescribed area; acquire a second image by setting the image-capturing conditions of the image-capturing device to second conditions and then capturing the prescribed area; and estimate a characteristic of the first conditions based on a comparison of a characteristic of the first image and a characteristic of the second image.
In an embodiment, (8) a control device includes a controller configured to acquire a first image by setting image-capturing conditions of an image-capturing device to first conditions and then capturing a prescribed area, acquire a second image by setting the image-capturing conditions of the image-capturing device to second conditions and then capturing the prescribed area, and estimate a characteristic of the first conditions based on a comparison of a characteristic of the first image and a characteristic of the second image.
In an embodiment, (9) an illumination control system includes: a control device; an illumination device configured to illuminate a prescribed area; and an image-capturing device configured to capture an image of the prescribed area. The control device is configured to acquire a first image by setting image-capturing conditions of an image-capturing device to first conditions and then capturing a prescribed area, acquire a second image by setting the image-capturing conditions of the image-capturing device to second conditions and then capturing the prescribed area, and estimate a characteristic of the first conditions based on a comparison of a characteristic of the first image and a characteristic of the second image.

1. An estimation method comprising:
acquiring a first image by setting image-capturing conditions of an image-capturing device to first conditions and then capturing a prescribed area;
acquiring a second image by setting the image-capturing conditions of the image-capturing device to second conditions and then capturing the prescribed area; and
estimating a characteristic of the first conditions based on a comparison of a characteristic of the first image and a characteristic of the second image.

2. The estimation method according to claim 1, further comprising:
setting a shutter speed to automatic adjustment and setting at least one condition other than the shutter speed to a fixed condition as the first conditions;
setting the shutter speed to a prescribed value and setting the at least one condition other than the shutter speed to the fixed condition as the second conditions;
comparing brightnesses of the first image and the second image as the characteristics of the first image and the second image; and
estimating an automatically adjusted value of the shutter speed at the time the first image was captured as the characteristic of the first conditions set as the image-capturing conditions of the image-capturing device.

3. The estimation method according to claim 1, further comprising:
estimating an illuminance of the prescribed area based on a result of estimating the characteristic of the first conditions and a characteristic of a third image capturing the prescribed area with the image-capturing conditions of the image-capturing device set to the first conditions.

4. The estimation method according to claim 3 further comprising:
determining whether the image-capturing device is operating in a prescribed mode based on the result of estimating the characteristic of the first conditions; and
when the image-capturing device is determined to be operating in the prescribed mode, reducing a frame rate at which the prescribed area is captured or stopping estimation of the illuminance of the prescribed area.

5. An illumination control method comprising:
controlling an illumination device installed in the prescribed area based on an estimated illuminance of the prescribed area obtained by performed the estimation method according to claim 3.

6. The illumination control method according to claim 5, comprising:
controlling a glare-free downlight as the illumination device.

7. A non-transitory computer readable medium storing an estimation program configured to cause a processor to:
acquire a first image by setting image-capturing conditions of an image-capturing device to first conditions and then capturing a prescribed area;
acquire a second image by setting the image-capturing conditions of the image-capturing device to second conditions and then capturing the prescribed area; and
estimate a characteristic of the first conditions based on a comparison of a characteristic of the first image and a characteristic of the second image.

8. A control device comprising:
a controller configured to
acquire a first image by setting image-capturing conditions of an image-capturing device to first conditions and then capturing a prescribed area;
acquire a second image by setting the image-capturing conditions of the image-capturing device to second conditions and then capturing the prescribed area; and
estimate a characteristic of the first conditions based on a comparison of a characteristic of the first image and a characteristic of the second image.

9. An illumination control system comprising:
the control device according to claim 8; an illumination device configured to illuminate a prescribed area; and an image-capturing device configured to capture the prescribed area.
